(19) United States
(12) Patent Application Publication
(10) Pub. No.: US 2013/0325196 A1
(43) Pub. Date: Dec. 5, 2013

(54) PERSONALIZED HEATING AND COOLING SYSTEMS

(71) Applicants: Sara H. Basson, White Plains, NY (US); Sachin Gupta, New Delhi (IN); Dimitri Kanevsky, Ossining, NY (US)

(72) Inventors: Sara H. Basson, White Plains, NY (US); Sachin Gupta, New Delhi (IN); Dimitri Kanevsky, Ossining, NY (US)

(73) Assignee: INTERNATIONAL BUSINESS MACHINES CORPORATION, Armonk, NY (US)

(21) Appl. No.: 13/484,403

(22) Filed: May 31, 2012

(51) Int. Cl. G05D 23/00

(52) U.S. Cl. 700/291

(57) ABSTRACT

Methods and arrangements for providing personalized heating and cooling. Personal clothing spot data relating to at least one quantifiable comfort condition are assimilated, as are ambient data relating to the at least one quantifiable comfort condition. The assimilated personal clothing spot data and assimilated ambient data are combined, and at least one comfort control arrangement is controlled via the combined data.

### BACKGROUND

Indoor environments are generally heated or cooled in order to ensure the comfort of inhabitants of that space. There is generally no linkage, however, between the setting of a thermostat and an individual's comfort level. Indeed, in many cases, rooms can be heated or cooled even though no one is physically present in the space. The result is wasted heating and cooling resources.

### BRIEF SUMMARY

In summary, one aspect of the invention provides a method comprising: assimilating personal clothing spot data relating to at least one quantifiable comfort condition; assimilating ambient data relating to the at least one quantifiable comfort condition; combining the assimilated personal clothing spot data and assimilated ambient data; controlling, via the combined data, at least one comfort control arrangement.

Another aspect of the invention provides an apparatus comprising: at least one processor; and a computer readable storage medium having computer readable program code embodied therewith and executable by the at least one processor, the computer readable program code comprising: computer readable program code configured to assimilate personal clothing spot data relating to at least one quantifiable comfort condition; computer readable program code configured to assimilate ambient data relating to the at least one quantifiable comfort condition; computer readable program code configured to combine the assimilated personal clothing spot data and assimilated ambient data; and computer readable program code configured to control, via the combined data, at least one comfort control arrangement.

An additional aspect of the invention provides a computer program product comprising: a computer readable storage medium having computer readable program code embodied therewith, the computer readable program code comprising: computer readable program code configured to assimilate personal clothing spot data relating to at least one quantifiable comfort condition; computer readable program code configured to assimilate ambient data relating to the at least one quantifiable comfort condition; computer readable program code configured to combine the assimilated personal clothing spot data and assimilated ambient data; and computer readable program code configured to control, via the combined data, at least one comfort control arrangement.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a personal heating and cooling system with components thereof.

FIG. 2 schematically illustrates a network energy resource manager.

FIG. 3 sets forth a process more generally for providing personalized heating and cooling.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that the various embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

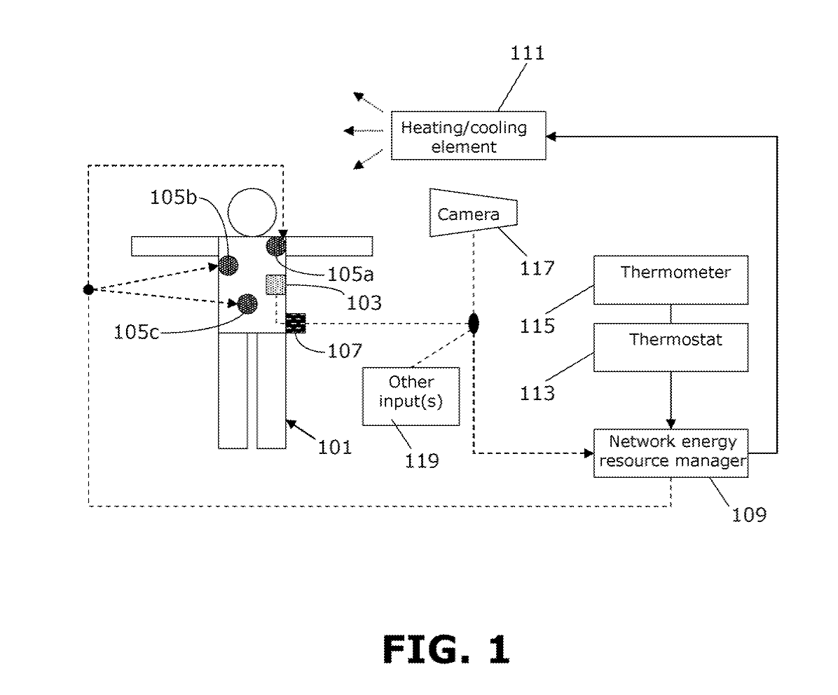

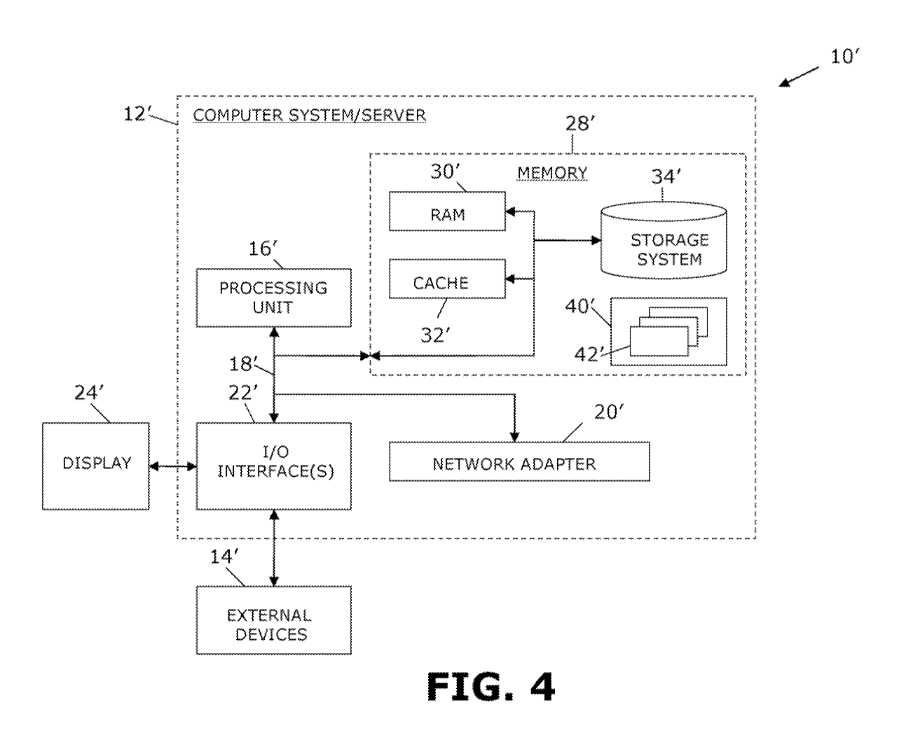

Specific reference will now be made herebelow to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

FIG. 1 schematically illustrates a personal heating and cooling system with personal components thereof, as broadly contemplated herein, in accordance with at least one embodiment of the invention. As such, a personal heating and cooling system that is associated with a clothing of a user 101 and can be referred to as “personal temperature regulator” (PTR). The PTR can be placed at various points in the user's clothing, so that the heat (or cold) is distributed evenly. The PTR system also wirelessly communicates with the room's thermostat, in order to ensure that heating and cooling resources are not squandered.

Thus, in accordance with at least one embodiment of the invention, components of a PTR can include a dress or clothing thermometer 103 (which can even be configured to measure other parameters such as humidity), and personal cooling/heating elements 105a/b/c for providing spot cooling or heating to a user. (There may be more than one thermometer/sensor 103 to be disposed at different points, but only one is shown here for the purposes of easier reference and illustration.) As such, a communication module 107 receiving temperature feedback (and even feedback for one or more other parameters such as humidity) from personal thermometer 103 can communicate wirelessly with a network energy resource manager 109 that accepts the feedback. Module 107 can be disposed essentially anywhere deemed suitable or comfortable on the person of a user 101, e.g., embedded in clothing, attached or adhered to the body, looped onto a belt, disposed in a pocket, etc. Resource manager 109, in turn, can regulate the personal elements 105a/b/c.

Additionally, in accordance with at least one embodiment of the invention, a room or apartment heating/cooling element 1.11, that is, an element that provides heat or cooling to a room, apartment, or a portion of a room or apartment, can also be controlled by resource manager 109. Additional input for the resource manager 109, in controlling personal elements 105a/b/c and/or room/apartment heating/cooling element 111, can be provided via a thermostat 113 and thermometer 115. In other words, a user can set the thermostat 113 for a room, apartment or portion of a room or apartment, with thermometer 115 providing feedback by way of helping control heating/cooling element 111. However, such control can also extend to personal elements 105a/b/c in accordance with any of a variety of parameters and considerations as broadly contemplated herein.

In accordance with at least one embodiment of the invention, if the PTR indicates that the temperature of user 101 is at target levels, then the external thermostat 113 can modify the room temperature accordingly. For example, air conditioning can be shut down if the person is sufficiently cool as indicated by the PTR. Thus, by way of an illustrative and non-restrictive example, in accordance with at least one embodiment of the invention, if the thermostat 113 is set at 75 degrees Fahrenheit, while the thermometer 115 reads 85 degrees Fahrenheit, this can reflect a typical thermostat setting in response to a high ambient room temperature. However, the thermostat 113 and cooling system (111) can be shut down if, indeed, individual elements 105a/b/c are already sufficient to keep user 101 cool, or within a desired (or predetermined) measured temperature range (as measured via personal thermometer 103).

In accordance with at least one embodiment of the invention, by way of alternative and/or additional inputs to network energy resource manager 109, a camera 117 located near the user 101 can send information about the clothing/dress of user 101 to an apartment, room or building cooling/heating system (e.g., controlled by network energy resource manager 109) that estimates user comfort conditions, and regulates a heating/conditioning system (e.g., which may include one or more heating/cooling elements 111) accordingly. For example, if the system, via camera 117, finds that user 101 is wearing a warm jacket or headgear, it can reduce heat to save energy. Thus, the heating/cooling system of a room, apartment, or room/apartment portion can adjust the heating/cooling delivered by element 111, while the thermostat/thermometer combination 113/115, as well, can essentially be modified or overridden by receipt and processing of the aforementioned visual data. (For background purposes, and by way of illustrative and non-restrictive example, arrangements for ascertaining a type of clothing worn by a user 101, and that can be employed in the context of embodiments of the invention, can be found in U.S. Pat. Nos. 6,763,148 [“Image Recognition Methods”, to Sternberg et al.] and 8,068,676 [“Intelligent Fashion Exploration Based on Clothes Recognition”, to Zhang et al.].)

In accordance with at least one embodiment of the invention, a system can use biometrics to determine a user's approximate age. For example, a baby may require a higher ambient temperature then an adult. Camera 117 can serve towards such an end. The system can also determine how comfortable a user is. For instance, it can use biometrics sensors to ascertain the degree of comfort of user 101, e.g., via camera 117 and associated analysis of user emotions, and/or via one or more sensors (such as that indicated at 103) placed on or about the body of user 101.

In accordance with at least one embodiment of the invention, other inputs 119 can be employed instead of or in conjunction with any or all of the inputs discussed heretofore. For instance, a historical database can provide data about the history of a user's comfort preferences, e.g., via logged thermostat data in a room normally occupied by user 101 and/or direct feedback provided from time to time by user 101. This can permit a prediction of the expected comfort of user 101 in given conditions. User input/feedback can also be provided, e.g., by harvesting information on a publicly available social network (or network posts), wherein an indication given by the user about his/her comfort level can prompt network energy resource manager 109 to adjust heating/cooling element 111 and/or individual elements 105a/b/c accordingly. (Such information can be sent, by way of an illustrative and non-restrictive example, via a mobile device or cellular phone, or via any other suitable input mechanism.)

It can also be recognized, in accordance with at least one embodiment of the invention, that there may be a problem in having one person override a heating/cooling setting in a way to make others uncomfortable. As such, network energy resource manager 109 can take into account the comfort of all users, and thereupon determine an optimized scheme that strikes a balance between the degrees of comfort of different users. Manager 109 may also permit temperature regulation in or within any room locally, and this may help address different user requirements or individual degrees of comfort.

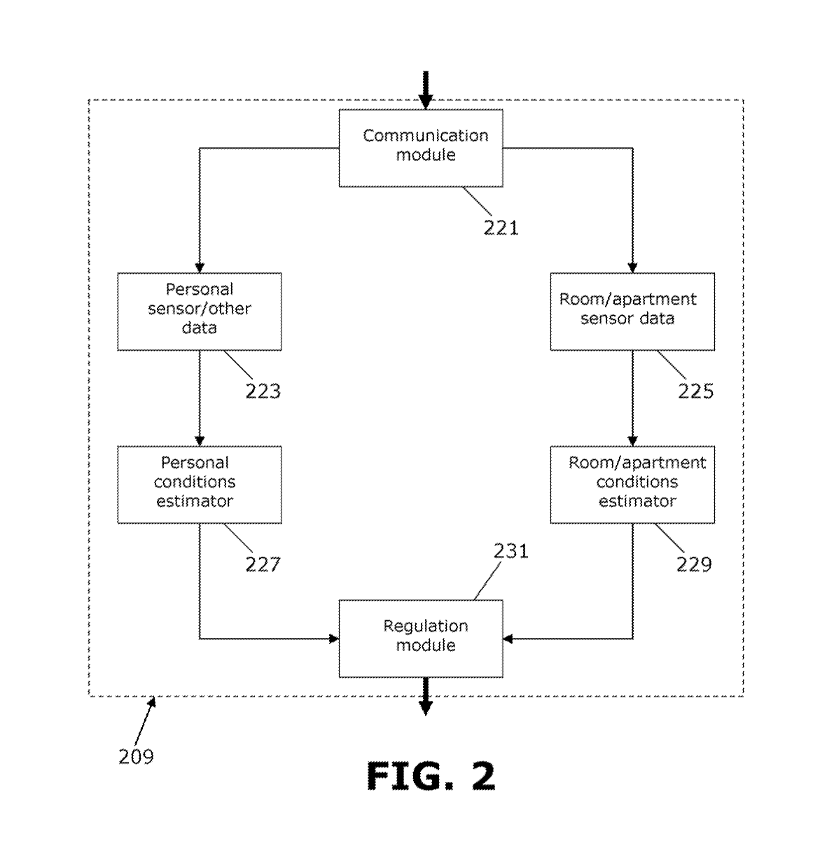

FIG. 2 schematically illustrates a network energy resource manager 209, in accordance with at least one embodiment of the invention. Indicated at 221 is a communication module that receives, e.g., from sensors in a room or apartment and from a user's clothing, information about temperatures in one or more locations and overall conditions of a user (e.g., type of clothing, user biometrics that can be used to identify user characteristics [such as approximate age], etc.). The data can be sent via wireless transmitters located in a user personal cooling/heating system and from transmitters connected to thermometers in a room.

In accordance with at least one embodiment of the invention, indicated by blocks 223 and 225 are sensor data retrieved from a user's clothing/dress (e.g., via a sensor 103 as shown and discussed with respect to FIG. 1), as well as from other inputs related to a user (e.g., a camera 117 and other inputs 119 as shown and discussed with respect to FIG. 1) and from room/apartment sensors (e.g., a thermometer 115 as shown and discussed with respect to FIG. 1), respectively. The data 223/225 are sent, respectively, to estimators which estimate personal heating/cooling conditions of a user (227) and local and/or ambient heating/cooling effects in a room/apartment (229). Such data permit a user to estimate if he/she is comfortable with his/her personal temperature. The estimation data are then sent to a regulation module 231, where regulation of a room/apartment heating/cooling system is undertaken. For example, if it is found that a user requires more heating, then the room/apartment heating system is activated to provide more heat at or near the user's location.

As discussed heretofore, such regulation can govern a local or ambient heating/cooling element such as that indicated at 101 in FIG. 1, and/or personal heating/cooling elements such as those indicated at 105a/b/c in FIG. 1.

By way of an illustrative and non-restrictive example of a general algorithm that can be employed in accordance with the process of FIG. 2, in accordance with at least one embodiment of the invention, a sparse regression method may be employed. As such, a matrix H can be formed with columns that contain vectors that represent clothing/dress sensor data from prior history. For each historical sensor data measurement, correspondence can be determined with categories or factors such as user satisfaction/comfort and whether or not the user may have been sick on an occasion. New data measurements are input as a vector Y, and a sparse vector X can then be found that satisfies Y=HX, where the dimension of vector X equals the number of columns in the matrix H. There can then be considered instances where there is a non-zero value of X in any of the columns. Most likely, a category that corresponds to non-zero entries in X yields a category to which just-measured sensor data in Y belongs, and this can assist in defining a user condition (based on Y).

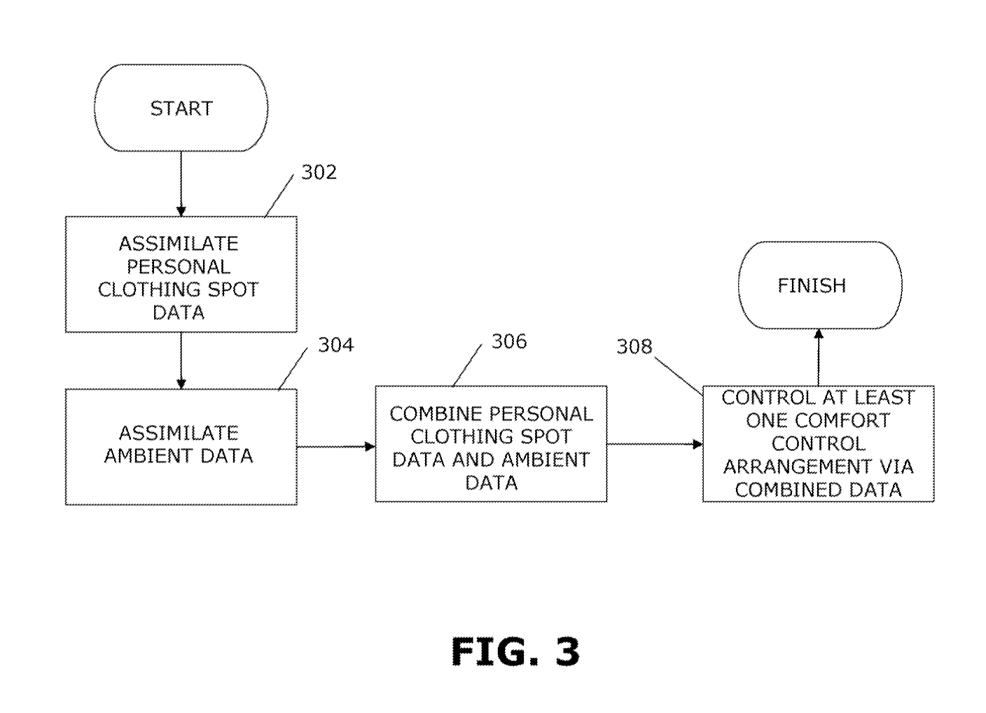

FIG. 3 sets forth a process more generally for providing personalized heating and cooling, in accordance with at least one embodiment of the invention. It should be appreciated that a process such as that broadly illustrated in FIG. 3 can be carried out on essentially any suitable computer system or set of computer systems, which may, by way of an illustrative and non-restrictive example, include a system such as that indicated at 12′ in FIG. 4. In accordance with an example embodiment, most if not all of the process steps discussed with respect to FIG. 4 can be performed by way a processing unit or units and system memory such as those indicated, respectively, at 16′ and 28′ in FIG. 4.

As shown in FIG. 3, personal clothing spot data relating to at least one quantifiable comfort condition are assimilated (302), as are ambient data relating to the at least one quantifiable comfort condition (304). The assimilated personal clothing spot data and assimilated ambient data are combined (306), and at least one comfort control arrangement is controlled via the combined data (308).

Referring now to FIG. 4, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples, include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
assimilating personal clothing spot data relating to at least one quantifiable comfort condition;
assimilating ambient data relating to the at least one quantifiable comfort condition;
combining the assimilated personal clothing spot data and assimilated ambient data;
controlling, via the combined data, at least one comfort control arrangement.

2. The method according to claim 1, wherein the at least one comfort control arrangement comprises an ambient temperature control system.

3. The method according to claim 1, wherein the at least one comfort control arrangement comprises a personal temperature control arrangement.

4. The method according to claim 1, wherein the at least one comfort control arrangement comprises a heating/cooling system.

5. The method according to claim 1, wherein said assimilating of personal clothing spot data comprises assimilating data from sensors disposed at a person.

6. The method according to claim 1, wherein said assimilating of ambient data comprises assimilating at least one member selected from the group consisting of: visual data relating to a person; historical comfort data relating to a person; and input provided by a person regarding personal comfort.

7. The method according to claim 6, wherein the input provided by a person regarding personal comfort comprises input provided via a social network.

8. The method according to claim 7, wherein the input provided via a social network is received from at least one member selected from the group consisting of: a mobile device; and a cellular phone.

9. The method according to claim 1, wherein said assimilating of ambient data comprises assimilating data from at least one member selected from the group consisting of: a collection of rooms; a room; and a room portion.

10. The method according to claim 1, wherein said assimilating of personal clothing spot data is performed prior to said assimilating of ambient data.

11. An apparatus comprising:
at least one processor; and
a computer readable storage medium having computer readable program code embodied therewith and executable by the at least one processor, the computer readable program code comprising:
computer readable program code configured to assimilate personal clothing spot data relating to at least one quantifiable comfort condition;
computer readable program code configured to assimilate ambient data relating to the at least one quantifiable comfort condition;
computer readable program code configured to combine the assimilated personal clothing spot data and assimilated ambient data; and
computer readable program code configured to control, via the combined data, at least one comfort control arrangement.

12. A computer program product comprising:
a computer readable storage medium having computer readable program code embodied therewith, the computer readable program code comprising:
computer readable program code configured to assimilate personal clothing spot data relating to at least one quantifiable comfort condition;
computer readable program code configured to assimilate ambient data relating to the at least one quantifiable comfort condition;
computer readable program code configured to combine the assimilated personal clothing spot data and assimilated ambient data; and
computer readable program code configured to control, via the combined data, at least one comfort control arrangement.

13. The computer program product according to claim 12, wherein the at least one comfort control arrangement comprises an ambient temperature control system.

14. The computer program product according to claim 12, wherein the at least one comfort control arrangement comprises a personal temperature control arrangement.

15. The computer program product according to claim 12, wherein the at least one comfort control arrangement comprises a heating/cooling system.

16. The computer program product according to claim 12, wherein said computer readable program code is configured to assimilate data from sensors disposed at a person.

17. The computer program product according to claim 12, wherein said computer readable program code is configured to assimilate at least one member selected from the group consisting of: visual data relating to a person; historical comfort data relating to a person; and input provided by a person regarding personal comfort.

18. The computer program product according to claim 12, wherein said computer readable program code is configured to assimilate data from at least one member selected from the group consisting of: a collection of rooms; a room; and a room portion.

19. The computer program product according to claim 18, wherein the input provided by a person regarding personal comfort comprises input provided via a social network.

20. The computer program product according to claim 12, wherein said computer readable program code is configured to assimilate personal clothing spot data prior to assimilating ambient data.
